(19) United States
(12) Patent Application Publication
(10) Pub. No.: US 2026/0177197 A1
(43) Pub. Date: Jun. 25, 2026

(54) SUPPORT FRAME FOR PRESSURE VESSELS

(71) Applicant: Worthington Cylinders GmbH, Kienberg bei Gaming (AT)

(72) Inventors: Christian Rasche, Witten (DE); Oliver Baer, Unna (DE)

(73) Assignee: Worthington Cylinders GmbH, Kienberg bei Gaming (AT)

(21) Appl. No.: 19/124,653

(22) PCT Filed: Oct. 11, 2023
(86) PCT No.: PCT/EP2023/078210

§ 371 Date: Apr. 25, 2025

(30) Foreign Application Priority Data
Oct. 25, 2022 (DE) 10 2022 128 202.3

(51) Int. Cl. F16M 11/24

(52) U.S. Cl. CPC F16M 11/24

(57) ABSTRACT

The invention relates to a support frame for securing pressure vessels, having two side struts (2) and at least one cross strut (3) extending between the two side struts (2), wherein a plurality of pressure vessels can be positioned between the side struts (2), which pressure vessels have a neck piece at one end, and wherein, for each pressure vessel, a holder is secured to the cross strut (3), to which holder the neck piece of the pressure vessel can be secured.

The object of the invention is to provide a cost-effective support frame that can be used very flexibly.

According to the invention, this object is attained in that at least one securing groove (11) extends along the cross strut (3) and in that each holder has a securing means (12) which engages in the securing groove (11) of the cross strut (3).

### TECHNICAL FIELD

This application relates to a support frame for securing pressure vessels and more particularly to a support frame having two side struts and at least one cross strut extending between the two side struts.

### BACKGROUND

A support frame for a pressure vessel is disclosed in patent application DE 10 2021 109 703 of the applicant. In this document, it is explained that pressure vessels for containing gas such as hydrogen or liquid gas are often designed as composite pressure vessels with a liner made of plastic or also of metal, e.g. aluminum, and have two neck pieces made of metal and arranged in the neck area and have a winding of a fiber composite material reinforcing the liner. Such pressure vessels are known, for example, from document WO 99/27293 A2. The neck pieces are also known as end bosses and are used to attach a filling and extraction valve. Such valves may be provided at both ends of the pressure vessel. Alternatively, one end of the pressure vessel may be closed. The neck pieces are also used to mount the pressure vessels on securing systems with which several pressure vessels can be secured to a vehicle, for example, and which include the support frame described here.

Securing systems for pressure vessels are known, for example, from documents CA 2 384 915 C, US 2004/0056164 A1 and US 2017/0370527 A1. The support frame shown in DE 10 2021 109 703 has two side struts, which are called longitudinal profiles therein and which consist of folded metal sheets. Further, the support frame of DE 10 2021 109 703 includes two cross struts, which are referred to therein as transverse profiles and which consist of machined metal profiles, in particular aluminum profiles.

A securing system for pressure vessels is known from CN 114151727 A, which has a clamp that grips around the circumference of the vessel. For size adjustment, the clamp has two parts that can be moved relative to each other using a crank using a gear mechanism. Each vessel is secured with three clamps and the crank is located on a long crank rod, which has three toothed sections for adjusting the size of each of the three clamps.

### SUMMARY OF THE INVENTION

It is desirable to provide a cost-effective support frame that can be used very flexibly.

According to the system described herein, a cost-effective support frame that can be used very flexibly is attained by having at least one securing groove extend along the cross strut and each holder having a securing mechanism which engages in the securing groove of the cross strut.

In other words, the cross strut, which extends between the two side struts, has a securing groove which extends in the axial direction of the cross strut. In particular, the cross strut may be an extruded profile. In this case, the securing groove extends over the entire length of the cross strut. The securing groove can be used to arrange a securing mechanism, which can be arranged in the securing groove in a cost-effective and very flexible manner. The securing mechanism can be moved along the securing groove so that the position of components of the securing mechanism can be varied along the length of the cross strut. In particular, if the cross strut is an extruded profile, especially an extruded aluminum profile, the manufacturing costs of the cross strut are low compared to a machined cross strut. The flexibility achieved by the securing position, movable along the length of the cross strut, of the securing mechanism enables strainless securing of the pressure vessels in practice.

In practice, at both of edges of the securing groove, the securing groove may have edge portions protruding towards the center of the securing groove. The edge portions may be engaged from behind by the securing mechanism. In particular, the securing mechanism may have a sliding block or a dovetail-shaped profile body that engages in the securing groove and is movable along the length of the securing groove. In practice, the securing mechanism may have a clamping element with which the securing mechanism can be fixed in the securing groove. In particular, the clamping element may be a clamping screw. The clamping screw can be used, for example, to pull the sliding block towards the securing mechanism and in this way clamp the edge of the securing groove. However, other clamping elements or tension elements may also be used. For example, quick-release levers are known which generate a tensile force via an eccentric and can thus cause the sliding block to be clamped in the securing groove. However, other known tension elements may also be used.

In practice, the support frame may have first securing elements for at least one pipe, each securing element having a securing mechanism that engages in a securing groove of the cross strut. In other words, not only the securing mechanism for the holders of the pressure vessels is fixed to the cross strut via a securing groove on the cross strut. A further securing mechanism is provided with which a pipe can be fixed to the cross strut. In practice, the support frame may have second securing elements for at least one cable, with each second securing element having a securing mechanism that engages in a securing groove of the cross strut. In this way, a similar securing mechanism is used for all components to be secured to the cross strut, namely for the holders of the pressure vessels and for the securing elements of pipes and cables.

In practice, the support frame may have one or more of the following features:
the securing mechanism of the holders engage in a first securing groove of the cross strut and the securing mechanism of the first and second securing elements engage in a second securing groove of the cross strut;
the first securing groove is located in a first surface of the cross strut;
the first surface faces upwards when the support frame is in the operating position;
the second securing groove is located in a second surface of the cross strut, which extends inclined towards the first surface of the cross strut;
the second surface faces outwards when the support frame is in the operating position.

Due to the fact that the securing groove for the holders of the pressure vessels is arranged on the upward-facing surface of the cross strut, the holders of the pressure vessels can be supported on the upward-facing surface of the cross strut. In this way, the heavy weight of the pressure vessels is safely transferred to the cross strut. The pipes and cables that lead to the neck pieces of the pressure vessels transfer significantly lower forces to the securing elements assigned to the securing elements than the pressure vessels. The securing elements can be easily attached to the outside, i.e., the side facing away from the inside of the support frame.

In practice, at least one channel may extend along the cross strut and a fixing screw may be screwed into the end of the channel. In particular, if the cross strut has been extruded, e.g., from aluminum, a profile of the cross strut may be provided with further profile sections which serve to mount the cross strut. In particular, several channels may extend along the length of the cross strut, the ends of which are each provided with an internal thread into which a fixing screw can be screwed.

In practice, the fixing screw may secure a side plate to the end of the cross strut. The side plate may be screwed to a side strut.

Further, in practice, the support frame may have at least one of the following features:
each side strut has an L-shaped profile;
each side strut consists of an extruded profile;
the cross strut connects first ends of the side struts;
a connecting strut extends between the second ends of the side struts.

The connecting strut may be designed identical to the cross strut. In particular, if the pressure vessels have neck pieces at both ends which are used to extract or supply gas, the neck pieces may be secured in an identical manner to the crosswise extending struts of the support frame. If, on the other hand, the second end of the pressure vessel is not used for the extraction or supply of gas, a simple profiled strut stabilizing the support frame may be arranged between the second ends of the side struts.

### BRIEF DESCRIPTION OF DRAWINGS

Further practical embodiments and advantages of the system described herein are described below in connection with the drawings.

FIG. 1 shows a three-dimensional view of a carrier from the front, to which four pressure vessels are secured via four holders according to the system described herein.

FIG. 2 shows a three-dimensional exploded view of the support frame of FIG. 1 according to the system described herein.

FIG. 3 shows an enlarged view of the front left corner of the support frame of FIG. 2 according to the system described herein.

### DESCRIPTION OF VARIOUS EMBODIMENTS

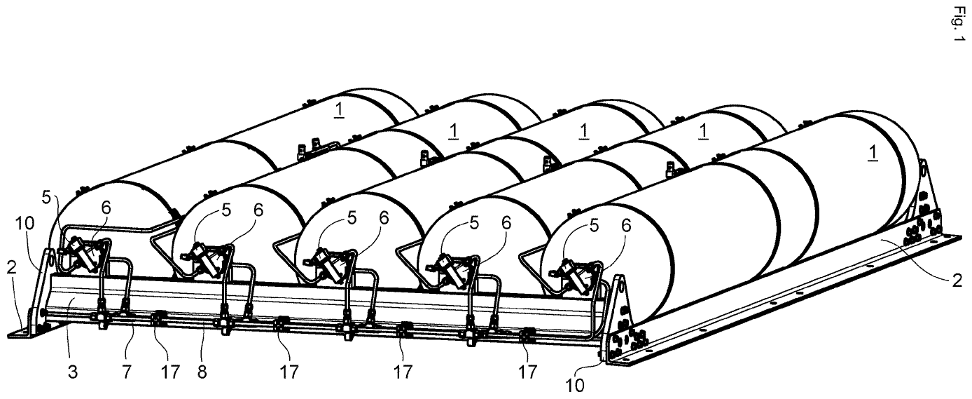

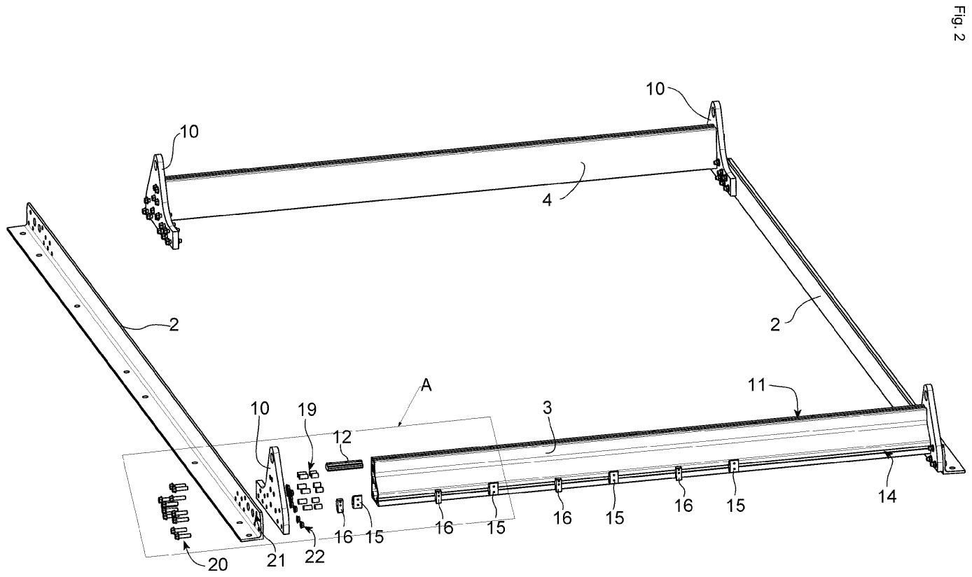

FIGS. 1 and 2 show a support frame for five pressure vessels 1, which is designed as a closed frame with two side struts 2, a front cross strut 3 and a rear transverse connecting strut 4 (FIG. 2). The rear connecting strut 4 may be designed identical to the front cross strut 3 and accommodate identical securing mechanisms. However, the rear connecting strut 4 may also be designed differently if fewer or no securing mechanisms are attached to the rear connecting strut 4.

The pressure vessels 1 may be used in particular to contain gaseous fuel for vehicles, for example liquid gas or hydrogen. The extraction valves 5 shown in FIG. 1, which control the flow of gas when refueling and emptying the pressure vessels 1, are arranged on the neck pieces of the pressure vessels 1. In FIG. 1, on the front cross strut 3, five holders 6 can be seen, with which the neck pieces with the extraction valves 5 are secured to the cross strut 3. The extraction valves 5 and the holders 6 cover the neck pieces in FIG. 1. The holders 6 fix the neck pieces of the pressure vessels 1, but at the same time ensuring a certain degree of flexibility. In particular, the pressure vessels 1 should not absorb any forces or momenta that act on the carrier. The forces and momenta acting on the carrier should largely be absorbed by the struts of the support frame. Deformations of the frame, but also deformations of the pressure vessels 1 depending on temperature and internal pressure, make it necessary for the neck pieces of the pressure vessels 1 to be held movably. For this purpose, the holders 6 may be designed as described in DE 10 2021 109 703.

A plurality of pipes 7, 8, 9 are connected to the extraction valves 5. The pipes 7, 8, 9, too, are secured to the cross strut 3. A side plate 10 is arranged at each end of the cross strut 3, via which side plate the cross strut 3 is connected to one end of the side struts 2. Similar or identical side plates 10 connect the rear ends of the side struts 2 to the rear connecting strut 4.

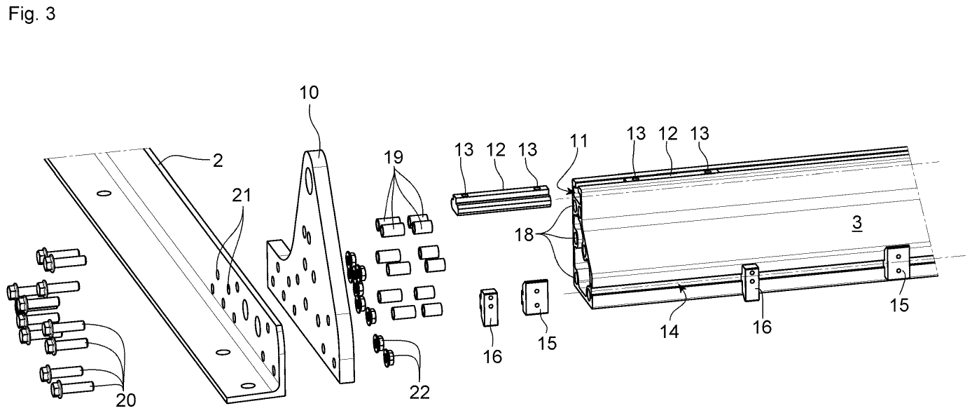

The structure of the support frame can be seen in FIGS. 2 and 3.

The cross strut 3 is designed as an extruded profile and is made of aluminum. The side of the cross strut 3 facing upwards in the operating position shown in FIGS. 2 and 3 has a first securing groove 11. Sliding blocks 12 are inserted into the securing groove 11, the profile of which substantially corresponds to the profile of the securing groove 11 and which can be inserted into the securing groove 11 with little play. Each sliding block 12 constitutes a securing mechanism for a holder 6. For this purpose, each sliding block 12 has two internal threads 13 (FIG. 3) into which fixing screws (not shown) for the holders 6 can be screwed. When the fixing screws are tightened in the internal threads 13, the sliding block 12 is clamped in the securing groove 11 and can no longer be moved sideways.

A second securing groove 14 is arranged on the outward-facing side of the cross strut 3, i.e., on the side facing away from the center of the support frame. Dovetail-shaped profile sections of further sliding blocks 15, 16 are inserted into the second securing groove 14, which further sliding blocks 15, 16 form movable securing mechanism for pipes and cables or other accessories. The sliding blocks 15 are slightly wider than the sliding blocks 16. Securing elements 17 are screwed to the sliding blocks 15 (FIG. 3), with which securing elements the pipes 7, 8 are secured to the cross strut 3. Securing elements (not shown) that carry cables or other accessories may be screwed to the sliding blocks 16. As mentioned, the sliding blocks 15, 16 may be arranged in a permanently movable manner in the second securing groove 14.

Alternatively, it is possible to provide a through hole with an internal thread in each of the sliding blocks 15, 16, into which through hole a locking screw is screwed in order to fix the sliding blocks 15, 16 in respective positions in the second securing groove 14.

When extruding the cross strut 3, it is perfectly possible to arrange additional securing grooves in a profile of the cross strut 3 if additional grooves are required for mounting the cross strut 3 or other add-on parts.

As can be seen in FIG. 3, the profile of the cross strut 3 has several channels 18 running in a longitudinal direction of the cross strut 3. A wire thread insert 19, such as wire thread inserts sold under the Helicoil brand, is inserted into the end of each channel. Screwed into the wire thread insert 19 is a fixing screw 20 projecting through a through hole in the side plate 10. In this way, six fixing screws 20 screwed into the ends of the channels 18 connect the side plate 10 to the end of the cross strut 3. Further fixing screws 20 project through screw holes 21, which are arranged in the end of the vertical flange of the L-shaped side strut 2. The further fixing screws 20 are screwed together with threaded nuts 22. In this way, the end of the L-shaped side strut 2 is firmly connected to the end of the cross strut via the side plate 10.

It should be noted that not all of the wire thread inserts 19, fixing screw 20, screw holes 21 and threaded nuts 22 in FIG. 3 are provided with a reference sign.

In this way, a firm connection is achieved between one end of the side struts 2 and one end of the cross strut 3 or the connecting strut 4 and a stable support frame is obtained.

Like the side struts 2, the connecting strut 4 at the rear in FIG. 2 may be a simple L-shaped extruded profile. However, the connecting strut 4 may also be designed identical to the cross strut 3 and hold securing elements located at the rear of the support frame.

The features of the invention disclosed in the present description, in the drawings and in the claims may be essential, both individually and in any combination, for the realization of the invention in its various embodiments. The invention is not limited to the described embodiments. The invention may be varied within the scope of the claims and taking into account the knowledge of the relevant person skilled in the art.

1. A support frame for securing pressure vessels, comprising:
two side struts;
at least one cross strut extending between the two side struts to accommodate a plurality of pressure vessels positioned between the side struts, each of the pressure vessels having a neck piece at one end;
a plurality of holders corresponding to each of the pressure vessels and secured to the cross strut to secure the neck pieces of the pressure vessels; and
at least one first securing groove that extends along the cross strut, wherein each of the holders has a first securing mechanism that engages in the first securing groove of the cross strut.

2. The support frame according to claim 1, wherein the cross strut is an extruded profile.

3. The support frame according to claim 1, wherein the first securing groove has edge portions projecting towards a center of the first securing groove at both edges thereof, the edge portions being engaged from behind by the first securing mechanism.

4. The support frame according to claim 1, wherein the first securing mechanism has a clamping element with which the first securing mechanism can be fixed in the first securing groove.

5. The support frame according to claim 4, wherein the clamping element is a clamping screw.

6. The support frame according to claim 1, further comprising:
first securing elements for at least one pipe, each of the first securing elements having a second securing mechanism which engages in a second securing groove of the cross strut.

7. The support frame according to claim 6, further comprising:
second securing elements for at least one cable, each of the securing element having a third securing mechanism which engages in the second securing groove of the cross strut.

8. The support frame according to claim 7, wherein the first securing groove is located in a first surface of the cross strut.

9. The support frame according to claim 1, wherein at least one channel extends along the cross strut and wherein a fixing screw is screwed into at least one end of the at least one channel.

10. The support frame according to claim 9, wherein the fixing screw secures a side plate to the end of the cross strut.

11. The support frame according to claim 10, wherein the side plate is screwed to at least one of the side struts.

12. The support frame according to claim 1, wherein each of the side struts has an L-shaped profile.

13. The support frame according to claim 8, wherein the first surface of the cross strut faces upwards when the support frame is in an operating position.

14. The support frame according to claim 13, wherein the second securing groove is located in a second surface of the cross strut that is inclined towards the first surface of the cross strut.

15. The support frame according to claim 14, wherein the second surface of the cross strut faces outwards when the support frame is in the operating position.

16. The support frame according to claim 1, wherein each side strut has an extruded profile.

17. The support frame according to claim 1, wherein the cross strut connects first ends of the side struts.

18. The support frame according to claim 17, further comprising:
a connecting strut that extends between second ends of the side struts.

19. The support frame according to claim 1, further comprising:
first securing elements for at least one pipe, each of the first securing elements having a second securing mechanism which engages in the first securing groove of the cross strut.

20. The support frame according to claim 19, further comprising:
second securing elements for at least one cable, each of the securing element having a third securing mechanism which engages in the first securing groove of the cross strut.
